(19) United States
(12) Patent Application Publication
(10) Pub. No.: US 2009/0001135 A1
(43) Pub. Date: Jan. 1, 2009

(54) SEMICONDUCTOR MANUFACTURING APPARATUS AND SEMICONDUCTOR MANUFACTURING METHOD

(75) Inventors: Makoto Kishimoto, Hyogo-ken (JP); Osamu Usuda, Hyogo-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/163,158

(22) Filed: Jun. 27, 2008

(30) Foreign Application Priority Data
Jun. 29, 2007 (JP) 2007-172530

(51) Int. Cl. B23K 20/10

(52) U.S. Cl. 228/110.1; 228/1.1

(57) ABSTRACT

A semiconductor manufacturing apparatus operable to simultaneously apply supersonic vibration to two bonding sites located at different heights to simultaneously perform bonding of the two bonding sites, the apparatus includes: a cylindrical body; a first protrusion provided on an outer peripheral surface of the cylindrical body and receiving supersonic vibration propagated through the cylindrical body; and a second protrusion provided on the outer peripheral surface of the cylindrical body and receiving supersonic vibration propagated through the cylindrical body. A distance between an axial center of the cylindrical body and the tip of the first protrusion is generally equal to the distance between the axial center of the cylindrical body and the tip of the second protrusion. A tip surface of the first protrusion and a tip surface of the second protrusion are on different planes, respectively.

### CROSS-REFERENCE TO RELATED APPLICATIONS

This application is based upon and claims the benefit of priority from the prior Japanese Patent Application No. 2007-172530, filed on Jun. 29, 2007; the entire contents of which are incorporated herein by reference.

### BACKGROUND OF THE INVENTION

1. Field of the Invention

This invention relates to a semiconductor manufacturing apparatus and semiconductor manufacturing method, and more particularly to a semiconductor manufacturing apparatus and a semiconductor manufacturing method used for supersonic bonding of a conductive strap to a semiconductor chip or a lead serving as an external connection terminal.

2. Background Art

Recently, with regard to semiconductor chips particularly for power applications, instead of wire bonding, a plate-shaped or strip-shaped strap of aluminum or copper has been proposed as a connecting structure between the chip and the external lead in view of lower resistance. For example, JP-A 2002-313851 (Kokai) discloses using supersonic vibration to bond a strap to a semiconductor chip or a lead.

To simultaneously apply supersonic vibration to two bonding sites having different heights (step heights) for bonding, two vibration applicators having step heights adapted to the step difference between the bonding sites need to be simultaneously pressed against the two respective bonding sites. However, in this configuration, depending on the positional relationship between the two vibration applicators, the distance between one vibration applicator and the supersonic vibration source may be considerably different from the distance between the other vibration applicator and the supersonic vibration source. If this difference is large, a great difference occurs between the longitudinal vibration intensities of supersonic vibration at the two vibration applicators. This causes a great variation in bonding performance between the two bonding sites.

### SUMMARY OF THE INVENTION

According to an aspect of the invention, there is provided a semiconductor manufacturing apparatus operable to simultaneously apply supersonic vibration to two bonding sites located at different heights to simultaneously perform bonding of the two bonding sites, the apparatus including: a cylindrical body; a first protrusion provided on an outer peripheral surface of the cylindrical body and receiving supersonic vibration propagated through the cylindrical body; and a second protrusion provided on the outer peripheral surface of the cylindrical body and receiving supersonic vibration propagated through the cylindrical body, a distance between an axial center of the cylindrical body and the tip of the first protrusion being generally equal to the distance between the axial center of the cylindrical body and the tip of the second protrusion, a tip surface of the first protrusion and a tip surface of the second protrusion being on different planes, respectively.

According to another aspect of the invention, there is provided a semiconductor manufacturing apparatus operable to simultaneously apply supersonic vibration to two bonding sites located at different heights to simultaneously perform bonding of the two bonding sites, the apparatus including: a cylindrical body; a first protrusion provided on an outer peripheral surface of the cylindrical body and receiving supersonic vibration propagated through the cylindrical body; and a second protrusion provided on the outer peripheral surface of the cylindrical body and receiving supersonic vibration propagated through the cylindrical body, a ratio of distances from an axial center of the cylindrical body to the tip of the first protrusion and the tip of the second protrusion being varied from a reference setting defined by a condition in which the distance between the axial center of the cylindrical body and the tip of the first protrusion is generally equal to the distance between the axial center of the cylindrical body and the tip of the second protrusion, a tip surface of the first protrusion and a tip surface of the second protrusion being on different planes, respectively.

According to another aspect of the invention, there is provided a semiconductor manufacturing method for simultaneously performing bonding of two bonding sites located at different heights, the method including pressing a tip of a first protrusion and a tip of a second protrusion to the two bonding sites, respectively, and simultaneously applying supersonic vibration to the two bonding sites, the first protrusion being provided on an outer peripheral surface of a cylindrical body and receiving the supersonic vibration propagated through the cylindrical body; and a second protrusion being provided on the outer peripheral surface of the cylindrical body and receiving the supersonic vibration propagated through the cylindrical body, a distance between an axial center of the cylindrical body and the tip of the first protrusion being generally equal to a distance between the axial center of the cylindrical body and the tip of the second protrusion, a tip surface of the first protrusion and a tip surface of the second protrusion are on different planes, respectively.

According to another aspect of the invention, there is provided a semiconductor manufacturing method for simultaneously performing bonding of two bonding sites located at different heights, the method including pressing a tip of a first protrusion and a tip of a second protrusion to the two bonding sites, respectively, and simultaneously applying supersonic vibration to the two bonding sites, the first protrusion being provided on an outer peripheral surface of a cylindrical body and receiving the supersonic vibration propagated through the cylindrical body; and a second protrusion provided on the outer peripheral surface of the cylindrical body and receiving the supersonic vibration propagated through the cylindrical body, a ratio of distances from an axial center of the cylindrical body to the tip of the first protrusion and the tip of the second protrusion being varied from a reference setting defined by a condition in which the distance between the axial center of the cylindrical body and the tip of the first protrusion is generally equal to the distance between the axial center of the cylindrical body and the tip of the second protrusion, a tip surface of the first protrusion and a tip surface of the second protrusion are on different planes, respectively.

### BRIEF DESCRIPTION OF THE DRAWINGS

FIG. 1 is an external perspective view of a supersonic bonding apparatus serving as a semiconductor manufacturing apparatus according to an embodiment of the invention;

FIG. 2 is an enlarged front view of the portion A in FIG. 1;

FIGS. 3A, 3B and 3C are schematic view showing the state of before bonding (A), the state during bonding (during application of supersonic vibration) (B) and the state after bonding (C) in the embodiment of the invention;

FIG. 4 is an enlarged front view similar to FIG. 2 of a supersonic bonding apparatus serving as a semiconductor manufacturing apparatus according to another embodiment of the invention;

FIG. 5 is an enlarged front view similar to FIG. 2 of a supersonic bonding apparatus serving as a semiconductor manufacturing apparatus according to still another embodiment of the invention; and

FIG. 6 is an enlarged front view of a supersonic bonding apparatus according to a comparative example, corresponding to FIG. 2 of the embodiment of the invention.

### DETAILED DESCRIPTION OF THE INVENTION

Embodiments of the invention will now be described with reference to the drawings.

In the present embodiments, a semiconductor manufacturing apparatus is described with reference to a bonding apparatus used for bonding a strap responsible for electrical connection between a semiconductor chip and a lead frame. The strap is bonded to the semiconductor chip and the lead frame by supersonic bonding.

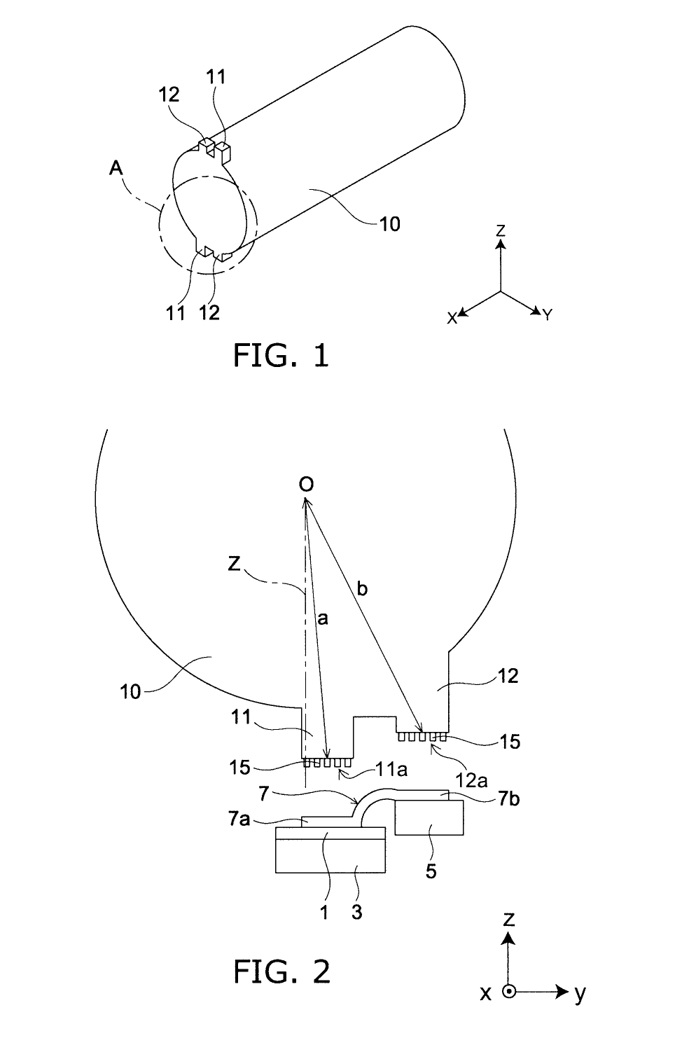

FIG. 1 is an external perspective view of a supersonic bonding apparatus (supersonic bonding tool) used for the supersonic bonding. FIG. 2 is an enlarged front view of the portion A in FIG. 1. FIG. 2 also shows a semiconductor chip 1, a lead frame 5, and a strap 7 connecting therebetween.

The supersonic bonding apparatus according to this embodiment comprises a cylindrical body 10, and a first protrusion 11 and a second protrusion 12 provided on the outer peripheral surface of the cylindrical body 10 near one of its axial end surfaces. Two pairs of the first protrusion 11 and the second protrusion 12 are illustratively provided on the outer peripheral surface of the cylindrical body 10 at 180° spacing in the example shown in FIG. 1. However, this is not limitative, but one pair, or three or more pairs thereof can be provided.

The first protrusion 11 and the second protrusion 12 are both shaped like a rectangular prism. Each has a pair of side surfaces generally parallel to the end surface of the cylindrical body 10, a pair of side surfaces generally perpendicular to the end surface of the cylindrical body 10, and a tip surface generally perpendicular to the end surface of the cylindrical body 10, and to the side surfaces. One of the four side surfaces of each of the first protrusion 11 and the second protrusion 12 is flush with the end surface of the cylindrical body 10. The protruding directions of the protrusions 11 and 12 are generally the same.

According to the embodiment of the invention, the tip surface 11a of the first protrusion 11 and the tip surface 12a of the second protrusion 12 are not on an common plane. The tip surface 11a of the first protrusion 11 and the tip surface 12a of the second protrusion 12 are parallel to each other. Hence, there is a step difference between the tip surface 11a of the first protrusion 11 and the tip surface 12a of the second protrusion 12.

Let z denote the line passing through the axial center O of the cylindrical body 10 and being parallel to the protruding direction of the first protrusion 11 and the second protrusion 12. Then, the respective centers of the first protrusion 11 and the second protrusion 12 (the centers of the rectangular tip surfaces) are not located across the line z. In the example shown in FIG. 2, the center of the first protrusion 11 and the center of the second protrusion 12 are located illustratively on the right side of the line z.

The distance a between the axial center O of the cylindrical body 10 and the center at the tip of the first protrusion 11 (the center of the rectangular tip surface) is generally equal to the distance b between the axial center O of the cylindrical body 10 and the center at the tip of the second protrusion 12 (the center of the rectangular tip surface).

The tip surfaces 11a and 12a of the first protrusion 11 and the second protrusion 12 are generally parallel to each other, and provided with a plurality of projections 15. The projections 15 have generally the same height (amount of projection).

A supersonic vibration source is provided at the axial center in the cylindrical body 10. Supersonic vibration generated therefrom is propagated through the cylindrical body 10 to the tip of each of the first protrusion 11 and the second protrusion 12. The longitudinal vibration direction (an lengthwise direction or an axial direction of the cylindrical body 10, or a direction parallel to the x-axis in FIGS. 1 and 2) of supersonic vibration at the tip of each of the first protrusion 11 and the second protrusion 12 is generally parallel to the associated tip surface.

Next, the target of supersonic bonding is described with reference to FIG. 2.

An integrated circuit including transistors and other devices is formed in the semiconductor chip 1. An electrode pad electrically connected to the integrated circuit is formed on each of the frontside and backside of the semiconductor chip 1. The integrated circuit and the electrode pads are formed in a wafer during the wafer process before separation into chips, and the semiconductor chip 1 is obtained after the subsequent dicing process. This is followed by a bonding process for connecting the semiconductor chip 1 to an external circuit, and a packaging (resin sealing) process.

Before the strap 7 is bonded to the semiconductor chip 1, the semiconductor chip 1 is bonded to a first lead frame 3. The electrode pad formed on the backside of the semiconductor chip 1 is bonded onto the frontside of the first lead frame 3 using a conductive bonding material such as solder or silver paste. The first lead frame 3 is made of a conductive material (such as copper) and electrically connected to the backside electrode pad of the semiconductor chip 1. The first lead frame 3 also serves as a support for supporting the semiconductor chip 1. The first lead frame 3 is connected to an external circuit through an external lead, not shown, provided on its backside, or formed integrally with its chip mounting portion.

The strap 7 is made of a conductive material such as copper and aluminum and shaped like a plate or strip. One end 7a of the strap 7 is supersonic bonded to the electrode pad formed on the frontside of the semiconductor chip 1, and the other end 7b is supersonic bonded to a second lead frame 5 made of a conductive material such as copper. The second lead frame 5 is connected to an external circuit through an external lead, not shown, formed integrally with the portion bonded to the strap 7.

The frontside of the semiconductor chip 1 and the bonding surface of the second lead frame 5 bonded to the strap 7 are located at different heights. Hence, the bonding portion between the strap 7 and the semiconductor chip 1 is stepped relative to the bonding portion between the strap 7 and the second lead frame 5. In this embodiment, the supersonic bonding apparatus described above is used to simultaneously apply supersonic vibration to two bonding sites located at such different heights, and the two bonding sites simultaneously undergo bonding.

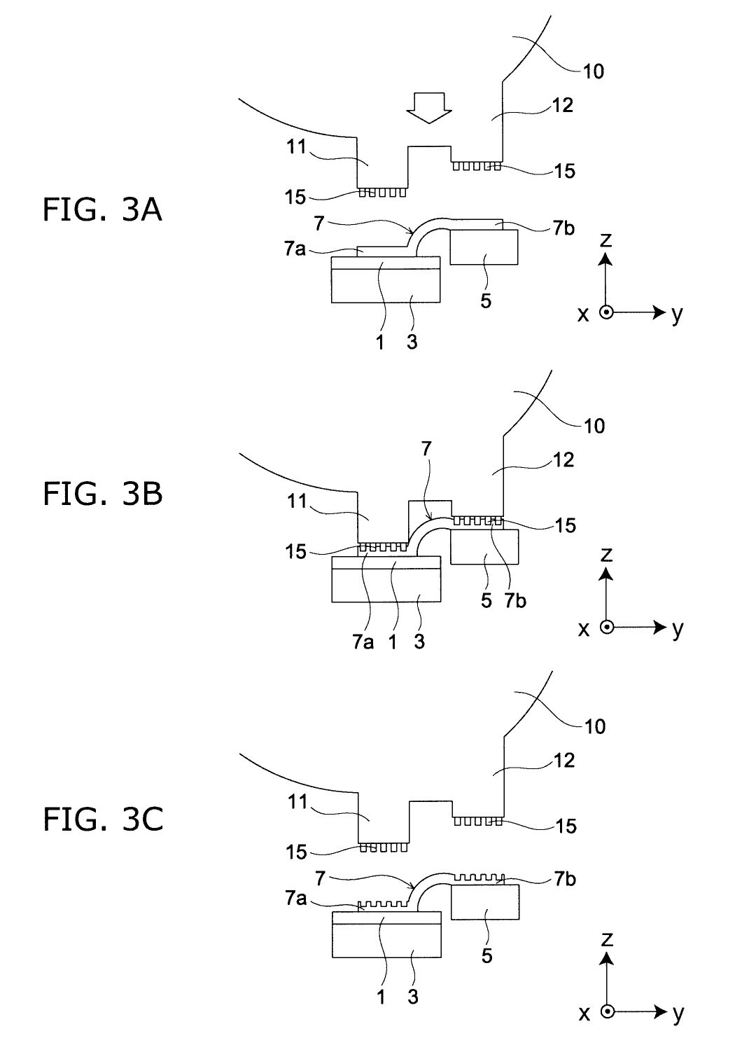

FIG. 3A shows the state before bonding, FIG. 3B shows the state during bonding (during application of supersonic vibration), and FIG. 3C shows the state after bonding.

In the state of FIG. 3A, the backside of the semiconductor chip 1 has already been bonded to the first lead frame 3, but the strap 7 is simply placed on the semiconductor chip 1 and the second lead frame 5, and not bonded thereto. The first lead frame 3 and the second lead frame 5 are supported on a stage, not shown. The first protrusion 11 and the second protrusion 12 together with the cylindrical body 10 are lowered toward the strap 7 at rest.

Then, as shown in FIG. 3B, the projections 15 provided at the tip surface 11a of the first protrusion 11 are pressed to the surface of one end 7a of the strap 7 placed on the semiconductor chip 1, and the projections 15 provided at the tip surface 12a of the second protrusion 12 are pressed to the surface of the other end 7b of the strap 7 placed on the second lead frame 5. In this state, supersonic vibration is applied through the first protrusion 11 to the bonding interface between the one end 7a of the strap 7 and the semiconductor chip 1, and simultaneously, supersonic vibration is applied through the second protrusion 12 to the bonding interface between the other end 7b of the strap 7 and the second lead frame 5. The longitudinal vibration direction of supersonic vibration at the bonding interface is parallel to the lengthwise (an axial) direction (x-direction in FIGS. 1 and 2) of the cylindrical body 10, and is generally parallel to the bonding interface.

The spaced distance between the first protrusion 11 and the second protrusion 12 is adapted to the spaced distance between the two bonding sites. Furthermore, the tip surface 11a of the first protrusion 11 and the tip surface 12a of the second protrusion 12 are provided on different parallel planes, respectively. Thus, a step difference is also provided between the tip of the first protrusion 11 and the tip of the second protrusion 12.

Simultaneous application of supersonic vibration to the above two bonding sites in the pressurized (pressed) state causes the two sites to simultaneously undergo bonding. More specifically, bonding of the frontside electrode pad of the semiconductor chip 1 to one end 7a of the strap 7 and bonding of the second lead frame 5 to the other end 7b of the strap 7 are simultaneously performed. This allows the frontside electrode pad of the semiconductor chip 1 to be electrically connected to an external circuit through the strap 7 and the second lead frame 5. Furthermore, the plurality of projections 15 provided at the tip surfaces 11a and 12a of the first protrusion 11 and the second protrusion 12 increase the pressing force exerted on the bonding surface, allowing enhancement of bonding strength.

After completion of bonding, as shown in FIG. 3C, the first protrusion 11 and the second protrusion 12 together with the cylindrical body 10 move upward and are detached from the strap 7. Fine impressions transferred from the configuration of the projections 15 remain on the surface of the strap 7 where the projections 15 of the first protrusion 11 and the second protrusion 12 have been pressed.

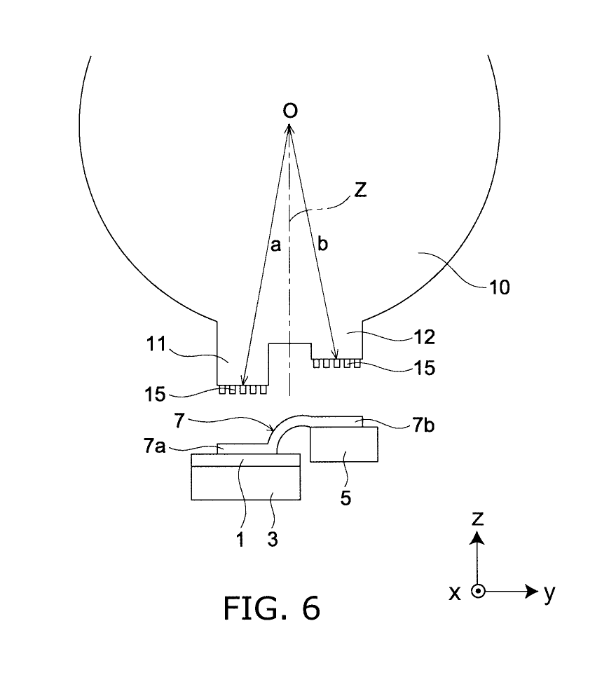

FIG. 6 is an enlarged front view of a supersonic bonding apparatus according to a comparative example, corresponding to FIG. 2 described above.

To simultaneously press two protrusions provided on the outer peripheral surface of a cylindrical body to two bonding sites having different heights (step heights) and apply supersonic vibration thereto for bonding, the tip surfaces of the two protrusions needs to be provided on different planes, respectively, in accordance with the step difference between the bonding sites. However, in this configuration, depending on the positional relationship between the protrusions, the distance between the tip of one protrusion and the supersonic vibration source (the axial center O of the cylindrical body 10) may be different from the distance between the tip of the other protrusion and the supersonic vibration source (the axial center O of the cylindrical body 10).

For instance, in the example shown in FIG. 6, the respective centers of the first protrusion 11 and the second protrusion 12 (the centers of the rectangular tip surfaces) are located across the line z, which passes through the axial center O of the cylindrical body 10 and is parallel to the protruding direction of the first protrusion 11 and the second protrusion 12. The distance a between the axial center O of the cylindrical body 10 and the center at the tip of the first protrusion 11 (the center of the rectangular tip surface) is different from (longer than) the distance b between the axial center O of the cylindrical body 10 and the center at the tip of the second protrusion 12 (the center of the rectangular tip surface).

If the distance a between the axial center O of the cylindrical body 10 and the tip of the first protrusion 11 is different from the distance b between the axial center O of the cylindrical body 10 and the tip of the second protrusion 12, the longitudinal vibration intensity of supersonic vibration at the tip of the first protrusion 11 is different from the longitudinal vibration intensity of supersonic vibration at the tip of the second protrusion 12.

In the case where the distance a is longer than the distance b, the longitudinal vibration intensity is smaller at the tip of the second protrusion 12 than at the tip of the first protrusion 11. Hence, even if good bonding is achieved between the semiconductor chip 1 and the strap 7, the bonding between the second lead frame 5 and the strap 7 may be insufficient. In this case, to enhance the bonding force between the second lead frame 5 and the strap 7, it may be contemplated to further urge the cylindrical body 10 downward to more strongly press the second protrusion 12 against the other end 7b of the strap 7. However, simultaneously, the downward pressing force of the first protrusion 11 integrated with the cylindrical body 10 is also increased and imposes an excessive stress on the semiconductor chip 1, which may be destroyed.

In contrast, in this embodiment, the placement of the first protrusion 11 and the second protrusion 12 is appropriately designed so that the distance a between the axial center O of the cylindrical body 10 and the tip of the first protrusion 11 is generally equal to the distance b between the axial center O of the cylindrical body 10 and the tip of the second protrusion 12. Because the distance a is generally equal to the distance b, the longitudinal vibration intensity at the tip of the first protrusion 11 is comparable to the longitudinal vibration intensity at the tip of the second protrusion 12. Thus, simultaneous bonding at two sites, that is, bonding of the semiconductor chip 1 to the strap 7 and bonding of the second lead frame 5 to the strap 7, can be favorably performed without bonding variation.

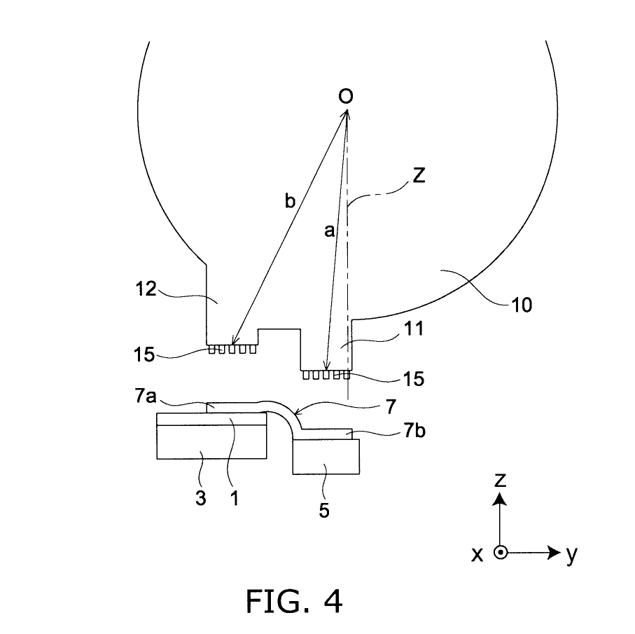

The above embodiment illustratively describes the case where the bonding portion between the second lead frame 5 and the strap 7 is located higher than the bonding portion between the semiconductor chip 1 and the strap 7. However, as shown in FIG. 4, the invention is also applicable to the case where the bonding portion between the semiconductor chip 1 and the strap 7 is located higher than the bonding portion between the second lead frame 5 and the strap 7.

More specifically, the tip of the first protrusion 11, which is located lower than the tip of the second protrusion 12, is pressed to the other end 7b of the strap 7 on the second lead frame 5, which is located lower than the frontside of the semiconductor chip 1. The tip of the second protrusion 12 is pressed to one end 7a of the strap 7 on the frontside of the semiconductor chip 1.

Also in this case, the placement of the first protrusion 11 and the second protrusion 12 is appropriately designed so that the distance a between the axial center O of the cylindrical body 10 and the tip of the first protrusion 11 is generally equal to the distance b between the axial center O of the cylindrical body 10 and the tip of the second protrusion 12. Hence, the longitudinal vibration intensity at the tip of the first protrusion 11 is comparable to the longitudinal vibration intensity at the tip of the second protrusion 12. Thus, simultaneous bonding at two sites with a step difference therebetween can be favorably performed without bonding variation.

Even in the configuration in which the distance a between the axial center O of the cylindrical body 10 and the tip of the first protrusion 11 is generally equal to the distance b between the axial center O of the cylindrical body 10 and the tip of the second protrusion 12, variation in bonding performance may occur between the two bonding sites depending on bonding conditions at the two bonding sites such as the material, mass, and strength of the bonded portions and the propagation property of supersonic vibration therein. Furthermore, from the viewpoint of avoiding damage to the semiconductor chip 1, the longitudinal vibration intensity of supersonic vibration applied may be preferably smaller at the bonding portion between the semiconductor chip 1 largely made of e.g. silicon and the strap 7 made of metal than at the bonding portion between the strap 7 and the second lead frame 5, which are both made of metal.

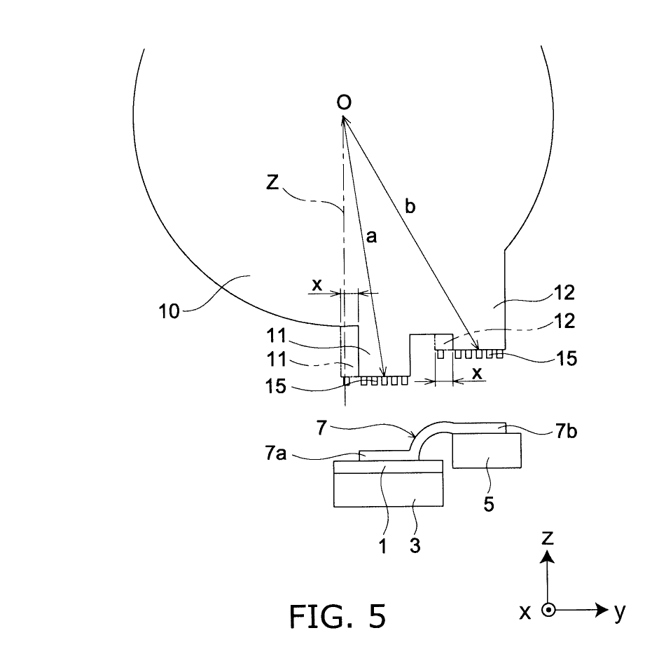

Thus, in an embodiment shown in FIG. 5, a reference setting is defined by the condition in which the distance a between the axial center O of the cylindrical body 10 and the tip of the first protrusion 11 is generally equal to the distance b between the axial center O of the cylindrical body 10 and the tip of the second protrusion 12 (the condition indicated by the double dot-dashed line). Depending on bonding conditions at the two bonding sites such as the material, mass, and strength of the bonded portions and the propagation property of supersonic vibration therein, the ratio of distances from the axial center O of the cylindrical body 10 to the tip of the first protrusion 11 and the tip of the second protrusion 12 is varied from the above reference setting.

For instance, in the example shown in FIG. 5, the first protrusion 11 and the second protrusion 12 are shifted by a distance x from the reference setting indicated by the double dot-dashed line in the y-direction (a lengthwise direction of the cylindrical body 10 and a direction perpendicular to the pressing direction) generally parallel to the longitudinal vibration. Thus, the distance a between the axial center O of the cylindrical body 10 and the tip of the first protrusion 11 is slightly shorter than the distance b between the axial center O of the cylindrical body 10 and the tip of the second protrusion 12. Hence, by that amount, the longitudinal vibration intensity at the tip of the first protrusion 11 is slightly weaker than the longitudinal vibration intensity at the tip of the second protrusion 12. This serves to avoid damage to the semiconductor chip 1 subjected to the pressing force and supersonic vibration applied through the first protrusion 11.

In this embodiment, a difference is intentionally provided between the distance a and the distance b depending on various bonding conditions. In setting this difference, the positions of the first protrusion 11 and the second protrusion 12 can be fine-tuned with respect to the reference setting so that they can be easily set to appropriate positions depending on various bonding conditions while avoiding undesirably large variation in bonding performance at the two bonding sites.

This embodiment is not limited to shifting both the first protrusion 11 and the second protrusion 12 with respect to the reference setting. It is also possible to shift only one of them with respect to the reference setting.

The embodiments of the invention have been described with reference to the examples. However, the invention is not limited thereto, but can be variously modified within the spirit of the invention.

The invention is not limited to bonding of a strap for electrically connecting a semiconductor chip to a lead frame, but is also applicable to bonding of a strap for electrically connecting between semiconductor chips.

1. A semiconductor manufacturing apparatus operable to simultaneously apply supersonic vibration to two bonding sites located at different heights to simultaneously perform bonding of the two bonding sites, the apparatus comprising:
a cylindrical body;
a first protrusion provided on an outer peripheral surface of the cylindrical body and receiving supersonic vibration propagated through the cylindrical body; and
a second protrusion provided on the outer peripheral surface of the cylindrical body and receiving supersonic vibration propagated through the cylindrical body,
a distance between an axial center of the cylindrical body and the tip of the first protrusion being generally equal to the distance between the axial center of the cylindrical body and the tip of the second protrusion,
a tip surface of the first protrusion and a tip surface of the second protrusion being on different planes, respectively.

2. The semiconductor manufacturing apparatus according to claim 1, wherein a plurality of projections are provided at the tip surface of the first protrusion and the tip surface of the second protrusion.

3. The semiconductor manufacturing apparatus according to claim 2, the plurality of projections have a generally equal height.

4. The semiconductor manufacturing apparatus according to claim 1, wherein the protruding direction of the first protrusion is generally parallel to the protruding direction of the second protrusion.

5. The semiconductor manufacturing apparatus according to claim 1, wherein the tip surface of the first protrusion is generally parallel to the tip surface of the second protrusion, and the longitudinal vibration direction of the supersonic vibration at the tip surface is generally parallel to the tip surface.

6. The semiconductor manufacturing apparatus according to claim 1, wherein the first protrusion and the second protrusion are provided on the outer peripheral surface of the cylindrical body near one of its axial end surfaces.

7. The semiconductor manufacturing apparatus according to claim 1, wherein a plurality of pairs of the first protrusion and the second protrusion are provided on the outer peripheral surface of the cylindrical body.

8. The semiconductor manufacturing apparatus according to claim 1, wherein the centers of the respective tip surfaces of the first protrusion and the second protrusion are not located across a line z passing through the axial center of the cylindrical body and being parallel to the protruding direction of the first protrusion and the second protrusion, but the center of the first protrusion and the center of the second protrusion are located on one side of the line z.

9. The semiconductor manufacturing apparatus according to claim 1, wherein the spaced distance between the first protrusion and the second protrusion is adapted to the spaced distance between the two bonding sites.

10. A semiconductor manufacturing apparatus operable to simultaneously apply supersonic vibration to two bonding sites located at different heights to simultaneously perform bonding of the two bonding sites, the apparatus comprising:
a cylindrical body;
a first protrusion provided on an outer peripheral surface of the cylindrical body and receiving supersonic vibration propagated through the cylindrical body; and
a second protrusion provided on the outer peripheral surface of the cylindrical body and receiving supersonic vibration propagated through the cylindrical body,
a ratio of distances from an axial center of the cylindrical body to the tip of the first protrusion and the tip of the second protrusion being varied from a reference setting defined by a condition in which the distance between the axial center of the cylindrical body and the tip of the first protrusion is generally equal to the distance between the axial center of the cylindrical body and the tip of the second protrusion,
a tip surface of the first protrusion and a tip surface of the second protrusion being on different planes, respectively.

11. The semiconductor manufacturing apparatus according to claim 10, wherein a plurality of projections are provided at the tip surface of the first protrusion and the tip surface of the second protrusion.

12. The semiconductor manufacturing apparatus according to claim 11, the plurality of projections have a generally equal height.

13. The semiconductor manufacturing apparatus according to claim 10, wherein the protruding direction of the first protrusion is generally parallel to the protruding direction of the second protrusion.

14. The semiconductor manufacturing apparatus according to claim 10, wherein the tip surface of the first protrusion is generally parallel to the tip surface of the second protrusion, and the longitudinal vibration direction of the supersonic vibration at the tip surface is generally parallel to the tip surface.

15. The semiconductor manufacturing apparatus according to claim 10, wherein the first protrusion and the second protrusion are provided on the outer peripheral surface of the cylindrical body near one of its axial end surfaces.

16. The semiconductor manufacturing apparatus according to claim 10, wherein a plurality of pairs of the first protrusion and the second protrusion are provided on the outer peripheral surface of the cylindrical body.

17. The semiconductor manufacturing apparatus according to claim 10, wherein the centers of the respective tip surfaces of the first protrusion and the second protrusion are not located across a line z passing through the axial center of the cylindrical body and being parallel to the protruding direction of the first protrusion and the second protrusion, but the center of the first protrusion and the center of the second protrusion are located on one side of the line z.

18. The semiconductor manufacturing apparatus according to claim 10, wherein the spaced distance between the first protrusion and the second protrusion is adapted to the spaced distance between the two bonding sites.

19. A semiconductor manufacturing method for simultaneously performing bonding of two bonding sites located at different heights, the method comprising pressing a tip of a first protrusion and a tip of a second protrusion to the two bonding sites, respectively, and simultaneously applying supersonic vibration to the two bonding sites,
the first protrusion being provided on an outer peripheral surface of a cylindrical body and receiving the supersonic vibration propagated through the cylindrical body; and
a second protrusion being provided on the outer peripheral surface of the cylindrical body and receiving the supersonic vibration propagated through the cylindrical body,
a distance between an axial center of the cylindrical body and the tip of the first protrusion being generally equal to a distance between the axial center of the cylindrical body and the tip of the second protrusion,
a tip surface of the first protrusion and a tip surface of the second protrusion are on different planes, respectively.

20. A semiconductor manufacturing method for simultaneously performing bonding of two bonding sites located at different heights, the method comprising pressing a tip of a first protrusion and a tip of a second protrusion to the two bonding sites, respectively, and simultaneously applying supersonic vibration to the two bonding sites,
the first protrusion being provided on an outer peripheral surface of a cylindrical body and receiving the supersonic vibration propagated through the cylindrical body; and
a second protrusion provided on the outer peripheral surface of the cylindrical body and receiving the supersonic vibration propagated through the cylindrical body,
a ratio of distances from an axial center of the cylindrical body to the tip of the first protrusion and the tip of the second protrusion being varied from a reference setting defined by a condition in which the distance between the axial center of the cylindrical body and the tip of the first protrusion is generally equal to the distance between the axial center of the cylindrical body and the tip of the second protrusion,
a tip surface of the first protrusion and a tip surface of the second protrusion are on different planes, respectively.
